(19) United States
(12) Patent Application Publication
(10) Pub. No.: US 2016/0195168 A1
(43) Pub. Date: Jul. 7, 2016

(54) COMET REDUCTION GEAR SHAFT ROTARY PISTON ENGINE

(71) Applicant: Yong Sak SUEBSINSKULCHAI, Bangkok (TH)

(72) Inventor: Yong Sak Suebsinskulchai, Bangkok (TH)

(21) Appl. No.: 14/910,862

(22) PCT Filed: Aug. 15, 2013
(86) PCT No.: PCT/TH2013/000036

§ 371 Date: Feb. 8, 2016

(51) Int. Cl. F16H 1/32; F04C 29/00

(52) U.S. Cl. CPC F16H 1/32; F04C 29/0057; F16H 2001/327

(57) ABSTRACT

A comet reduction gear shaft rotary piston engine consists of a triangular rotor (3) rotated in a rotor housing (1) and side housings (2). The comet reduction gear set comprises of two sets of internal engaging gears, wherein, the big set (4, 20, 5) and the small set (5, 6) are fitting uniquely together. The comet reduction gear shaft rotary piston engine has two systems of output shaft. The comet reduction gear shaft rotary piston engine has high thermal efficiency and reduces overall wear and tear of the engine.

### BACKGROUND OF INVENTION

The rotary piston engine is an internal combustion engine, when it compared to the conventional reciprocating engine has several disadvantages. The drawbacks are: low output torque, high fuel consumption, and high exhaust gas temperature.

The main problem of this situation is the inefficiency of power transmitted from the rotor to the output shaft by eccentric shaft.

This invention is set out to improve the efficiency of power transmission by designing and replacing the eccentric shaft with a new set of gears shaft called “the comet reduction gears shaft” and the method for attaching the comet reduction gear shaft to the rotary piston engine.

What is “the comet reduction gears shaft?” The comet reduction gear shaft is the comet reduction gear set mount on the output shaft (No,9), rotor (No,3), and fix to front or rear side housing (No,2), the rotor rotates on the rotor bearing (No,11) in the middle of front and rear of side housing (No,2).

The comet reduction gears set consist of two sets of internal engaging gear fitting uniquely together, the big set and the small set. The big set comprises of one internal gear (No, 4), one inner ring gear (No, 5,), and one outer ring gear spacer (No,20). The small set comprises of one inner ring gear (No,5) and one external gear (No,6). The ratio of external gear, inner ring gear, internal gear is 2:3:4 respectively.

The rotary piston engine comprised of the triangular rotor (No, 3) rotated in the rotor housing (No,1) and the side housing (front and rear)(No,2). The comet reduction gear shaft is the comet reduction gear set mounted on the output shaft. To provide higher power output of original rotary piston engine or eccentric shaft rotary piston engine, by replaces the eccentric shaft with the comet reduction gear shaft.

The comet reduction gear set comprised of two sets of internal engaging gears. The big set (No, 4,5,20) and the small set. (No, 5,6). The inner ring gear (No,5) fixed to both sides of rotor, one side engaged to the external gear (No,6), is mounted on the output shaft (No,9). There is an outer ring gear spacer (No,20) inserted into the other side of rotor. The other side of outer ring gear spacer is engaged to the internal gear (No,4), which is fixed in the side housing (No,2).

The outer ring gear spacer (No,20) pack in one unit with the side spacer (No,19) and rotated on the eccentric spacer (No,8). When the rotor rotated by the expansion of ignited gas, the power transmitted through the gear set converts to torque higher efficiency than eccentric shaft up to 96%.

The comet reduction gear shaft rotary piston engine has two systems of output shaft.

System I. Fixed internal gear (No.4) to the side housing (No,2). The external gear, (No. 6) mounts on the main output shaft (No,9). When the rotor drives the ring gear (No,5). The ratio of the output shaft is 3 times of the rotor revolution, as shown in drawing FIGS. 1.&2 (suitable for Diesel cycle).

System II. Fixed external gear (No.6) to the side housing (No,2). The internal gear, (No,4) mount on the main output shaft (No,9). When the rotor drives the ring gear (No.5). The ratio of output shaft is 1.5 time of the rotor revolution, as shown in drawing FIGS. 3&4. (suitable for Otto cycle)

This invention is easy to assembly, because the external gear (No,6) and outer ring gear spacer (No,20) both have the same dimension. It can engage or insert to the inner ring gear at any side of rotor. (No,3).

Single rotor engine in System I. Fixed internal gear (No,4) in the front side housing (No,2). The main components are shown in drawing FIGS. 1&2. Rotor housing (No.1), side housing (No. 2), front and rear. Rotor (No.3) equipped each side with the inner ring gear. (No,5). Comet reduction gear set, the internal gear (No.4) fixed in the front side housing (No. 2), engaged to the outer ring gear spacer (No.20) which pack in set in the side spacer (No. 19) and inserted in one side of inner ring gear (No.5) of rotor (No,3). The external gear (No. 6) mounted on the output shaft (No.9) engaged to the inner ring gear (No.5) on the other side of rotor. (No,3)

Single rotor engine in System II. The main components are shown in drawing FIGS. 3&4. The components (No 1, 2, and 3), are the same as in single rotor engine in System I. The comet reduction gear set, comprise of an external gear (No. 6) fixed in the front side housing (No. 2), engaged to an inner ring gear (No.5) side of rotor. (No,3). The internal gear (No. 4) mounted on the output shaft (No. 9), engaged to the outer ring gear space (No. 20), which insert to the other inner ring gear (No.5) side of rotor, (No,3) to form the comet reduction gear shaft on the main output shaft (No. 9).

By calculation. The comet reduction gear shaft rotary piston engine can produce output torque higher more than double the original rotary piston engine at the same speed (in System 1). And more than 4 times at 1.5 times the piston speed (in System II).

### SUMMARY OF THE INVENTION

The inventor invented a model of the comet reduction gear set to show how does it work. The comet reduction gear set rotates in motion similar to the eccentric shaft except direction.

The comet reduction gear shaft is a series of gears driving each others to provide smoother power while being higher in power output. The comet reduction gear shaft rotary piston engine has two systems of output shaft and can be operated in 2-stroke or 4-stroke engine in Otto cycle or Diesel cycle and also can be used in stream engine.

In system I, the ratio of the output shaft is triple of the rotor revolution. similar to Wankle design. In system II, the ratio of output shaft is 1.5 times that of the rotor revolution.

The machine elements must be produced according to DIN or JIS and ASTM standards. The fitting of machine parts. For small part fit by force fit. For medium parts fit by screw and nut or machine bolt. For moving parts fit by keyway. The external gear (No,6) fit to the housing, fit by offsetting the bolts fit on the outside of the housing.

The part call inner ring gear (No,5) is not the internal gear (No,4). The inner ring gear (No,5) is fitted to both side of rotor (No,3). The internal gear (No,4) is fitted to the side housing (No,2) or main output shaft (No,9). The external gear (No,6) mounts on the main output shaft or fitted to the side housing (No,2), according to System 1 or System II.

The reciprocating engine is an internal combustion engine has low in power per weight ratio, but has the high thermal efficiency. The gas turbine has high in power per weight ratio, bus has low in thermal efficiency. The comet reduction gear shaft rotary piston engine lay in between. It has high in power per weight ratio and has high in thermal efficiency, because it is the close cycle of internal combustion engine.

Because of the advantages of the rotary piston engine itself (i.e, no reciprocating motion, no heavy flywheel, and no valve character,) combined with high performance when transmitted by comet reduction gear shaft. The comet reduction gear shaft rotary piston engine is significant, a higher speed can be reached with lower vibration, lower fuel consumption, lower the noise level, and higher power per weight ratio. Lead-free gasoline, diesel fuel, liquid natural gas, biogas and hydrogen can be utilized. As the result of the Otto cycle or the Diesel cycle, the engine have high thermal efficiency. After more than 50 years of unsuccessfulness of the eccentric shaft rotary piston engine. The new rotary piston engine call “comet reduction gear shaft” rotary piston engine will certainly be the decisive winner of the 21^{st} century

### DESCRIPTION OF DRAWING

FIG. 1. Cross section of the comet reduction gear shaft. No 4, 5, and 20, to form the big set, and No, 5,6 to form the small set. In System I.

FIG. 2. Longitude section of single rotor comet reduction gear shaft rotary piston engine. In System 1. The internal gear (No. 4) fitted to the front housing (No.2). The external gear (No. 6) mounted on the output shaft (No. 9) on the rear side of the engine.

FIG. 3. Cross section of the comet reduction gear shaft. No. 4, 5, and 20, to form the big set, and No 5,6 to form the small set. In System II.

FIG. 4. Longitude section of single rotor comet reduction gear shaft rotary piston engine. In System II. The external gear (No,6) fitted in the front housing (No.2). The internal gear (No.4) mounted on the output shaft (No.9) on the rear side of the engine.

The main components of comet reduction gears shaft rotary piston engine. 1 Rotor housing. 2 Side housing (front & rear). 3 Rotor. 4 Internal gear. 5 Inner ring gear. 6 External gear. 7 Intermediate housing. 8 Eccentric spacer. 9 Main output shaft. 10 Main bearing. 11 Rotor bearing, hollow shaft bearing. 12 Starting wheel. 13 Flywheel. 14 Inlet port. 15 Exhaust port. 16 Spark plug. 17 Apex seal. 18 Spacer wheel. 19 Side spacer. 20 Outer ring gear spacer.

What is claimed is:

1. The comet reduction gear shaft rotary piston engine consist of rotary housing (No,1), side housing (front & rear) (No,2) and rotor (No,3). The comet reduction gear set comprise of two sets of internal engaging gears, the big set (No 4, 20, 5,) and the small set (No 5,6,) mount on the rotor (No,3) and main output shaft (No,9). The rotor (No,3) rotate on the main bearing (No, 10) in the middle of front and rear of side housing (No,2).

2. According to claim 1. The big set of comet reduction gear set consists of three parts of gear (No, 4, 20, 5). One outer ring gear spacer (No,20) one inner ring gear (No,5) and one internal gear (No,4). The small set consist of two parts of gear (No,5,6) the inner ring gear (No,5.) and the external gear. (No,6) The ratio of external gear to ring gear and internal gear is 2:3:4 respectively.

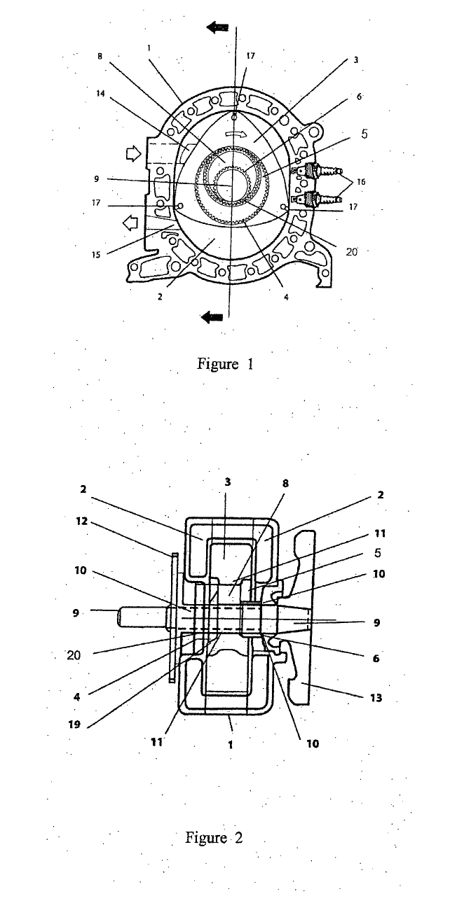

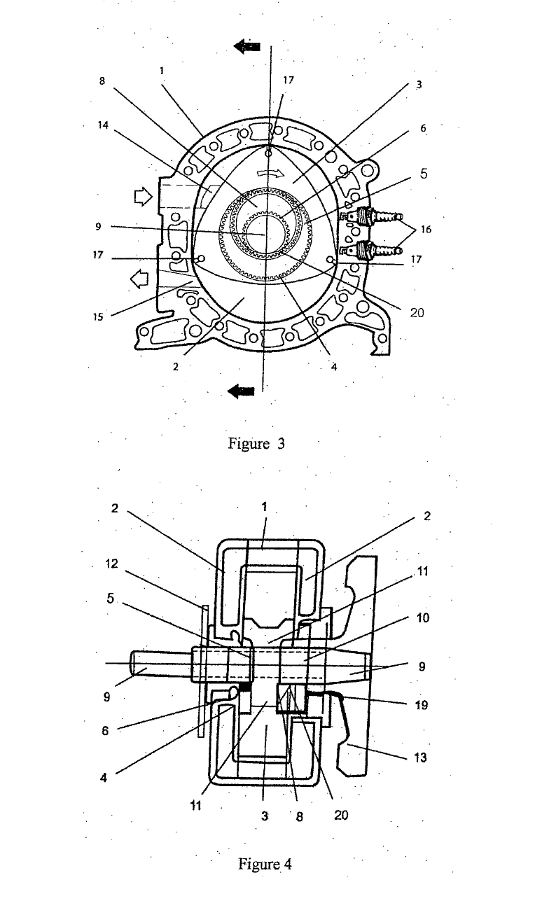

3. According to claim 1. The comet reduction gear shaft rotary piston engine has two systems of output shaft. System 1 (FIGS. 1&2), wherein the internal gear (No,4) is fixed to the housing (front, and rear) (No,2), the external gear (No,6) is mounted on the main output shaft (No,9). System 2 (FIGS. 3&4), wherein the external gear (No,6) is fixed to the housing (front, and rear) (No,2) and the internal gear (No,4) is mounted on the main output shaft (No,9).
